(19) United States
(12) Patent Application Publication
(10) Pub. No.: US 2026/0227558 A1
(43) Pub. Date: Aug. 6, 2026

(54) REFLECTIVE POLARIZER WITH CONTROLLED REFLECTION-DEPTH DISPERSION

(71) Applicant: 3M INNOVATIVE PROPERTIES COMPANY, St. Paul, MN (US)

(72) Inventors: Gilles J. Benoit, Minneapolis, MN (US); Lin Zhao, Woodbury, MN (US); John D. Le, San Jose, CA (US); David J.W. Aastuen, Shoreview, MN (US)

(21) Appl. No.: 19/151,756

(22) PCT Filed: Feb. 22, 2024
(86) PCT No.: PCT/IB2024/051727

§ 371 Date: Jul. 29, 2025

Related U.S. Application Data
(60) Provisional application No. 63/448,695, filed on Feb. 28, 2023.

(51) Int. Cl. G02B 5/30; G02B 27/00

(52) U.S. Cl. CPC G02B 5/305; G02B 5/3083; G02B 27/0025

(57) ABSTRACT

An optical film includes optical repeat units (ORUs) co-extruded and co-stretched with one another and numbering at least 10 in total. Each ORU has an average thickness of less than about 1500 nm and includes at least a polymeric A layer and a different polymer B layer. When adjacent data points in a scatter plot of thicknesses versus the numbers of the ORUs are connected with straight line segments to form a continuous line plot, the continuous line plot has a plurality of first lines where the ORU thickness in all of the first lines increases with a same one of increasing and decreasing ORU number, alternating with, and intersecting, a plurality of second lines where the ORU thickness in all of the second lines decreases with the same one of increasing and decreasing ORU number. The intersection points form at least three peaks alternating with at least two valleys.

### SUMMARY

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. The ORUs are sequentially numbered from a same first major side of the optical film to an opposite, second major side of the optical film. When adjacent data points in a scatter plot of thicknesses versus the numbers of the ORUs are connected with straight line segments to form a continuous line plot, then the continuous line plot includes a plurality of first lines where the ORU thickness in all of the first lines increases with a same one of increasing and decreasing ORU number, alternating with, and intersecting, a plurality of second lines where the ORU thickness in all of the second lines decreases with the same one of increasing and decreasing ORU number. The intersection points form at least three peaks alternating with at least two valleys.

In some aspects of the present description, an optical film is provided, the optical film including a plurality of optical repeat units (ORUs) co-extruded and co-stretched with one another and numbering at least 10 in total. Each of the ORUs has a peak reflectivity at a corresponding resonant wavelength (RW) and includes at least a polymeric A layer and a different polymer B layer. When in a scatter plot of the RWs of the ORUs versus depths of the ORUs relative to a same major side of the optical film, adjacent data points are connected with straight line segments to form a continuous line plot, then the continuous line plot includes a plurality of first lines where the ORU RW in all of the first lines increases with a same one of increasing and decreasing ORU depth, alternating with, and intersecting, a plurality of second lines where the ORU RW in all of the second lines decreases with the same one of increasing and decreasing ORU depth, the intersection points forming at least three peaks alternating with at least two valleys.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. The ORUs in the plurality of the ORUs are sequentially numbered from a same first major side of the optical film to an opposite second major side of the optical film. A scatter plot of the thicknesses versus the numbers of the ORUs has at least three non-overlapping groups of the ORUs. Each of the groups includes at least 3 of the sequentially numbered ORUs in the plurality of ORUs including first and second ORUs having respective maximum and minimum thicknesses among the at least three ORUs in the group. The minimum and maximum thicknesses in the group differ from each other by at least 15%. For each of the first ORUs and the second ORUs in the at least three non-overlapping groups of the ORUs, the thicknesses of the ORUs are within about 10% of each other.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. Each of the ORUs has a peak reflectivity at a corresponding resonant wavelength (RW). A scatter plot of the RWs of the ORUs versus depths of the ORUs relative to a same major side of the optical film includes at least three non-overlapping groups of the ORUs. Each of the groups includes at least 3 of the sequentially numbered ORUs in the plurality of ORUs including first and second ORUs having respective maximum and minimum RWs among the at least three ORUs in the group. The minimum and maximum RWs in the group differ from each other by at least 15%. For each of the first ORUs and the second ORUs in the at least three non-overlapping groups of the ORUs, the RWs of the ORUs are within about 10% of each other.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. The ORUs in the plurality of the ORUs are sequentially numbered from a same first major side of the optical film to an opposite second major side of the optical film. A scatter plot of a thickness versus the number of the ORUs includes at least three groups of the ORUs. Adjacent groups in the at least three groups are separated from each other by at least one of the ORUs not in any of the at least three groups. Each of the at least three groups includes at least 3 of the ORUs that have a thickness between a same minimum thickness and a same maximum thickness. The minimum and maximum thicknesses different from each other by at least 15%.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. Each of the ORUs has a peak reflectivity at a corresponding resonant wavelength (RW). A scatter plot of the RWs of the ORUs versus depths of the ORUs relative to a same major side of the optical film includes at least three groups of the ORUs. Adjacent groups in the at least three groups are separated from each other by at least one of the ORUs not in any of the at least three groups. Each of the at least three groups includes at least 3 of the ORUs that have a RW between a same minimum RW and a same maximum RW. The minimum and maximum RWs differ from each other by at least 15%.

In some aspects of the present description, an optical film is provided, the optical film including at least three non-overlapping optical packets stacked along a thickness direction of the optical film and co-extruded and co-stretched with one another. Each of the at least three optical packets includes a plurality of optical repeat units ORUs. Each of the ORUs has an average thickness of less than about 1500 nm and includes at least a polymeric A layer and a different polymer B layer. The ORUs in the at least three non-overlapping optical packets are sequentially numbered from a same first major side of the optical film to an opposite second major side of the optical film. A scatter plot of a thickness versus the number of the sequentially numbered ORUs in the at least three non-overlapping optical packets includes at least first, second, and third non-overlapping scatter plots of the sequentially numbered ORUs in one-to-one correspondence to the at least three optical packets. Each of the at least first, second, and third non-overlapping scatter plots include at least 3 of the sequentially numbered ORUs in the plurality of ORUs, wherein a best linear fit to each of at least two of the at least the first through the third scatter plots has a slope having a magnitude of greater than about 0.7 nm per ORU number.

In some aspects of the present description, an optical film is provided, the optical film including at least three non-overlapping optical packets stacked along a thickness direction of the optical film and co-extruded and co-stretched with one another. Each of the at least three optical packets includes a plurality of optical repeat units ORUs. Each of the ORUs includes at least a polymeric A layer and a different polymer B layer and has a peak reflectivity at a corresponding resonant wavelength (RW) disposed in a wavelength range from about 200 nm to about 2000 nm. A scatter plot of the RWs versus depths of the ORUs in the at least three optical packets, the depths relative to a same major side of the optical film, includes at least first, second, and third non-overlapping scatter plots of the ORUs. Each of the at least first, second, and third non-overlapping scatter plots include at least 3 of the ORUs in the plurality of ORUs. A magnitude of a second-order coefficient of a best second degree polynomial fit to each of at least two of the at least the first through the third scatter plots has a magnitude of greater than about 0.016.

In some aspects of the present description, an optical film is provided, the optical film including at least three non-overlapping optical packets stacked along a thickness direction of the optical film and co-extruded and co-stretched with one another. Each of the at least three optical packets comprising at least three optical repeat units ORUs. Each of the ORUs has an average thickness of less than about 1500 nm and includes at least a polymeric A layer and a different polymer B layer. The ORUs in the at least three optical packets are sequentially numbered from a same first major side of the optical film to an opposite second major side of the optical film. A scatter plot of a thickness versus the number of the sequentially numbered ORUs in the at least three optical packets includes at least first, second, and third non-overlapping scatter plots of the sequentially numbered ORUs in one-to-one correspondence to the at least three optical packets. Magnitudes of slopes of best linear fits to at least two of the at least the first through the third scatter plots are different by at least about 20%.

In some aspects of the present description, an optical film is provided, the optical film including at least three non-overlapping optical packets stacked along a thickness direction of the optical film and co-extruded and co-stretched with one another. Each of the at least three optical packets includes at least three optical repeat units ORUs. Each of the ORUs includes at least a polymeric A layer and a different polymer B layer and has a peak reflectivity at a corresponding resonant wavelength (RW) disposed in a wavelength range from about 200 nm to about 2000 nm. A scatter plot of the RWs versus depths of the ORUs in the at least three optical packets, the depths relative to a same major side of the optical film, includes at least first, second, and third non-overlapping scatter plots of the ORUs. Each of the at least first, second, and third non-overlapping scatter plots includes at least 3 of the ORUs in the plurality of ORUs. Magnitudes of second-order coefficients of best second-degree polynomial fits to at least two of the at least the first through the third scatter plots are different by at least 20%.

In some aspects of the present description, an optical film is provided, the optical film including at least three non-overlapping optical packets stacked along a thickness direction of the optical film and co-extruded and co-stretched with one another. Each of the at least three optical packets include at least three optical repeat units ORUs. Each of the ORUs includes at least a polymeric A layer and a different polymer B layer and has a peak reflectivity at a corresponding resonant wavelength (RW) disposed in a wavelength range from about 200 nm to about 2000 nm. A plot of the RWs versus depths of the ORUs in the at least three optical packets, the depths relative to a same major side of the optical film, includes at least first, second, and third non-overlapping plots of the ORUs. Each of the at least first, second, and third non-overlapping plots include at least 3 of the ORUs in the plurality of ORUs and has a slope defining a rate of change of the RW with respect to the depth at a same first RW. Magnitudes of the slopes of at least two of the at least the first through the third plots are different by at least 20%.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. For at least first, second, and third ORU thicknesses, different from each other by at least 10 nm, the optical film includes at least three first ORUs, at least three second ORUs, and at least three third ORUs that have thicknesses within 20% of the respective first, second, and third ORU thicknesses. For each of the at least three first ORUs, the at least three second ORUs, and the at least three third ORUs, the ORUs are spaced apart along a thickness direction of the optical film by at least 2 microns.

In some aspects of the present description, an optical film is provided, the optical film including a plurality of optical repeat units (ORUs) co-extruded and co-stretched with one another and numbering at least 10 in total. Each of the ORUs includes at least a polymeric A layer and a different polymer B layer. For a substantially collimated light incident on the optical film at a first incident angle, for at least one polarization state, and for at least first blue, first green, and first red wavelengths in respective blue, green, and red wavelength ranges extending from about respective 420 nm, 490 nm, and 590 nm to about respective 480 nm, 560 nm, and 670 nm, the optical film includes at least three blue ORUs, at least three green ORUs, and at least three red ORUs that have resonant wavelengths within 20% of the respective first blue, green, and red wavelengths. For each of the at least three blue ORUs, the at least three green ORUs, and the at least three red ORUs, the ORUs are spaced apart along a thickness direction of the optical film by at least 2 microns.

In some aspects of the present description, an optical film is provided, the optical film including a plurality of optical repeat units (ORUs) co-extruded and co-stretched with one another and numbering at least 10 in total. Each of the ORUs has an average thickness of less than about 1500 nm and includes at least a polymeric A layer and a different polymer B layer. The ORUs in the plurality of the ORUs are sequentially numbered from a same first major side of the optical film to an opposite second major side of the optical film. A scatter plot of the average thicknesses versus the numbers of the sequentially numbered ORUs in the plurality of the optical packets includes at least three non-overlapping groups of the ORUs. Each of the groups including at least 3 of the sequentially numbered ORUs in the plurality of ORUs. For each pair of adjacent first and second groups in the plurality of the groups, the first group includes a first ORU closest to the second group and the second group includes a second ORU closest to the first group, wherein the thicknesses of the first and second ORUs are different by at least 20%. For a substantially collimated light incident on the optical film at a first incident angle, for at least one polarization state, and for at least a first wavelength in a visible wavelength range extending from about 420 nm to about 680 nm, the plurality of the ORUs and at least one of the groups in the at least three non-overlapping groups, have respective optical reflectances R and R1 wherein R>R1>15%, and R/R1≥1.1.

In some aspects of the present description, an optical film is provided, the optical film including a plurality of polymeric layers stacked along a thickness direction of the optical film. Each of the polymeric layers has an average thickness of less than about 500 nm. When an optical light ray having a first visible wavelength in a visible wavelength range extending from about 420 nm to about 680 nm is incident on the plurality of polymeric layers at a first incident angle of at least 10 degrees, the plurality of polymeric layers reflects the incident light as a reflected light having a plurality of spaced apart substantially parallel reflected light rays. Each of the reflected light rays has the first visible wavelength. A separation between at least two adjacent reflected light rays in the plurality of reflected light rays is greater than an average total thickness of at least 10 sequentially stacked polymeric layers in the plurality of polymeric layers.

In some aspects of the present description, an optical film is provided, the optical film including a plurality of polymeric layers stacked along a thickness direction of the optical film. When a substantially monochromatic light ray having an optical intensity Ii is incident on the plurality of polymeric layers at a first incident angle of at least 5 degrees, the plurality of polymeric layers reflects the incident light ray as at least two spaced apart reflected light rays having corresponding at least two optical intensities Ira and Irb. Each of ratios Ira/Ii and Irb/Ii is greater than about 0.1, and at least one of the ratios Ira/Ii and Irb/Ii is less than about 0.9.

In some aspects of the present description, an optical system is provided, the optical system including a display, at least one optical component having chromatic dispersion, and an optical film having a plurality of polymeric layers and configured to at least partially compensate for the chromatic dispersion of the at least one optical component. The display is configured to form and emit an image comprising coincident first and second emitted image rays having respective first and second wavelengths at least about 20 nm apart. The optical system is configured to display a virtual image of the emitted image to a viewer. An optical interaction between the at least one optical component and the coincident first and second emitted image rays laterally separates the first and second emitted image rays so that, when incident on the optical film, the first and second emitted image rays have respective optical intensities I1 and I2 and are separated by a first distance P1. The optical film reflects the incident first and second emitted image rays as respective reflected first and second image rays having respective optical intensities Q1 and Q2 and separated by a second distance P2, such that Q1/I1≥0.15, Q2/I2≥0.15, and P2 is less than P1 by at least 10%.

### BRIEF DESCRIPTION OF THE DRAWINGS

FIG. 1 is a side view of an optical film including a plurality of optical repeat units (ORUs), in accordance with an embodiment of the present description;

FIGS. 2A and 2B provide scatter plots of thicknesses versus the numbers of the ORUs for an optical film, in accordance with an embodiment of the present description;

FIGS. 3A and 3B provide scatter plots of the resonant wavelengths of the ORUs versus the depths of the ORUs, in accordance with an embodiment of the present description;

FIGS. 4A and 4B provide an alternate view of the scatter plots of thicknesses versus the numbers of the ORUs for an optical film, in accordance with another alternate embodiment of the present description;

FIGS. 5A and 5B provide an alternate view of the scatter plots of the resonant wavelengths of the ORUs versus the depths of the ORUs, in accordance with an embodiment of the present description;

FIG. 6 provides an alternate view of a scatter plot of thicknesses versus the numbers of the ORUs for an optical film, in accordance with an embodiment of the present description;

FIG. 7 provides an alternate scatter plot of thicknesses versus the numbers of the ORUs for an optical film, in accordance with an embodiment of the present description;

FIG. 8 provides an alternate scatter plot of the resonant wavelengths of the ORUs versus the depths of the ORUs, in accordance with an embodiment of the present description;

FIG. 9 provides an alternate scatter plot of the resonant wavelengths of the ORUs versus the depths of the ORUs, in accordance with another alternate embodiment of the present description;

FIG. 10 provides a plot of the rate of change of the resonant wavelength with respect to the depth at a same first resonant wavelength, in accordance with another alternate embodiment of the present description;

FIG. 11 provided a scatter plot of thicknesses versus the depths of the ORUs for an optical film, in accordance with an embodiment of the present description;

FIG. 12 shows a substantially collimated light incident on optical film at a first incident angle, in accordance with an embodiment of the present description;

FIG. 13 provides a plot of resonant wavelengths of the ORUs versus the depths of the ORUs for an optical film, in accordance with an embodiment of the present description;

FIGS. 14A and 14B provide plots of reflectance versus wavelength for an optical film, in accordance with an embodiment of the present description;

FIG. 15 is a side view of an optical stack for an optical film with controlled reflection-depth dispersion, in accordance with an embodiment of the present description; and

FIG. 16 is a side view of an optical system with controlled reflection-depth dispersion, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Multilayer optical films (MOFs) are interference stacks that reflect light by stacking together quarter-wave layers with high refractive index contrast. Each bi-layer unit cell is characterized by a reflection band with intrinsic optical power and bandwidth determined by the index contrast and the f-ratio of the unit cell. Because the intrinsic optical power and bandwidth of a single unit cell are usually too weak and narrow for any practical application, many unit cells are stacked and graded to increase overall optical power and bandwidth. As a result, different wavelengths reflect at different depths within the MOF depending on which unit cells are on or off resonance. In most applications, this reflection-depth dispersion does not noticeably impact key performance metrics. In imaging optics applications however, this characteristic can induce a lateral shift of rays of different wavelength and lead to chromatic aberration, pixel blur, loss of resolution and other artifacts. Other optical components, such as lenses, can also induce chromatic aberration and it is common in imaging systems to add a compensation lens to correct for the overall chromatic aberration. The ability to tune and engineer a reflection-depth dispersion within the MOF, such as a reflective polarizer in a polarizing beam splitter or a folded-optics lens, could mitigate, and in some instances eliminate, chromatic aberration.

According to some aspects of the present description, an optical film may include a plurality of optical repeat units (ORUs) co-extruded and co-stretched with one another. An optical repeat unit are formed by pairs of adjacent microlayers, and each ORU has an optical thickness equal to the sum of the optical thicknesses of its constituent microlayers.

In some embodiments, the ORUs number at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm and may include at least a polymeric A layer (microlayer) and a different polymer B layer (microlayer). In some embodiments, the ORUs are sequentially numbered from a same first major side (e.g., a “top” side) of the optical film to an opposite second major side (e.g., a “bottom” side) of the optical film. In some embodiments, the optical film may be a reflective polarizer.

In some embodiments, when adjacent data points in a scatter plot of thicknesses versus the numbers of the ORUs are connected with straight line segments to form a continuous line plot, then the continuous line plot may include a plurality of first lines where the ORU thickness in all of the first lines increases with a same one of increasing and decreasing ORU number, alternating with, and intersecting, a plurality of second lines where the ORU thickness in all of the second lines decreases with the same one of increasing and decreasing ORU number. In some embodiments, the intersection points may form at least three peaks alternating with at least two valleys.

In some embodiments, at least two of the first lines in the plurality of the first lines may be substantially parallel. In some embodiments, at least two of the second lines in the plurality of the second lines may be substantially parallel.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have a peak reflectivity at a corresponding resonant wavelength (RW) and may include at least a polymeric A layer and a different polymer B layer.

In some embodiments, when in a scatter plot of the RWs of the ORUs versus depths of the ORUs relative to a same major side of the optical film, adjacent data points are connected with straight line segments to form a continuous line plot, then the continuous line plot may include a plurality of first lines where the ORU RW in all of the first lines substantially increases with a same one of increasing and decreasing ORU depth, alternating with, and intersecting, a plurality of second lines where the ORU RW in all of the second lines substantially decreases with the same one of increasing and decreasing ORU depth, the intersection points forming at least three peaks alternating with at least two valleys.

For the purposes of this specification, a resonant wavelength, or RW, is defined as a wavelength at which a given ORU exhibits peak reflectivity. The peak reflectivity, however, and thus the resonant wavelength, changes as a function of incident angle and polarization. For normally incident light, the resonant wavelength equals two times the optical thickness of the ORU. At oblique angles, the resonant wavelength is less than the resonant wavelength at normal incidence, and furthermore it is in general different for s-polarized light and p-polarized light.

Also, for the purposes of this specification, the terms “substantially increases” and “substantially decreases” (e.g., as in “the continuous line plot may include a plurality of first lines where the ORU RW in all of the first lines substantially increases with a same one of increasing and decreasing ORU depth”) shall be assumed to mean that the increase or decrease occurs in a general sense with the changing ORU number or ORU depth, while allowing for noise and/or process variations which may vary from the general trend. That is, while the RW or thickness may generally increase or decrease with changing ORU number or depth, one or more pairs of adjacent plot points may be reversed from the overall trend.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm. In some embodiments, each of the ORUs may include at least a polymeric A layer and a different polymer B layer. In some embodiments, the ORUs in the plurality of the ORUs may be sequentially numbered from a same first major side of the optical film to an opposite second major side of the optical film.

In some embodiments, a scatter plot of the thicknesses versus the numbers of the ORUs may include at least three non-overlapping groups of the ORUs. In some embodiments, each of the groups may include at least 3, or at least 5, or at least 10, or at least 15, or at least 20, or at least 25, or at least 30, or at least 50 of the sequentially numbered ORUs in the plurality of ORUs including first and second ORUs having respective maximum and minimum thicknesses among the at least three ORUs in the group. In some embodiments, the minimum and maximum thicknesses in the group may differ from each other by at least 15%, or at least 20%, or at least 25%, or at least 30%, or at least 35%, or at least 40%, or at least 45%, or at least 50%, or at least 55%, or at least 60%, or at least 65%, or at least 70%. In some embodiments, for each of the first ORUs and the second ORUs in the at least three non-overlapping groups of the ORUs, the thicknesses of the ORUs may be within about 10% of each other.

According to some aspects of the present description, an optical film may include a plurality of optical repeat units (ORUs) co-extruded and co-stretched with one another. In some embodiments, the ORUs may number at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm, and may include at least a polymeric A layer and a different polymer B layer.

In some embodiments, each of the ORUs may have a peak reflectivity at a corresponding resonant wavelength (RW). In some embodiments, a scatter plot of the RWs of the ORUs versus depths of the ORUs relative to a same major side of the optical film may include at least three non-overlapping groups of the ORUs. In some embodiments, each of the groups may include at least 3, or at least 5, or at least 10, or at least 15, or at least 20, or at least 25, or at least 30, or at least 50 of the sequentially numbered ORUs in the plurality of ORUs, including first and second ORUs having respective maximum and minimum RWs among the at least three ORUs in the group. In some embodiments, the minimum and maximum RWs in the group may be different from each other by at least 15%, or at least 20%, or at least 25%, or at least 30%, or at least 35%, or at least 40%, or at least 45%, or at least 50%, or at least 55%, or at least 60%, or at least 65%, or at least 70%.

In some embodiments, for each of the first ORUs and the second ORUs in the at least three non-overlapping groups of the ORUs, the RWs of the ORUs may be within about 10% of each other.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or about 200 nm and may include at least a polymeric A layer and a different polymer B layer. In some embodiments, the ORUs in the plurality of the ORUs may be sequentially numbered from a same first major side of the optical film to an opposite second major side of the optical film.

In some embodiments, a scatter plot of a thickness versus the number of the ORUs includes at least three groups of the ORUs. In some embodiments, adjacent groups in the at least three groups may be separated from each other by at least one of the ORUs not in any of the at least three groups. In some embodiments, each of the at least three groups may include at least 3, or at least 5, or at least 10, or at least 15, or at least 20, or at least 25, or at least 30, or at least 50 of the ORUs that have a thickness between a same minimum thickness and a same maximum thickness. In some embodiments, the minimum and maximum thicknesses may be different from each other by at least 15%, or at least 20%, or at least 25%, or at least 30%, or at least 35%, or at least 40%, or at least 45%, or at least 50%, or at least 55%, or at least 60%, or at least 65%, or at least 70%.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm, and may include at least a polymeric A layer and a different polymer B layer. In some embodiments, each of the ORUs may have a peak reflectivity at a corresponding resonant wavelength (RW).

In some embodiments, a scatter plot of the RWs of the ORUs versus depths of the ORUs relative to a same major side of the optical film may include at least three groups of the ORUs. In some embodiments, adjacent groups in the at least three groups may be separated from each other by at least one of the ORUs not in any of the at least three groups. In some embodiments, each of the at least three groups may include at least 3, or at least 5, or at least 10, or at least 15, or at least 20, or at least 25, or at least 30, or at least 50 of the ORUs that have a RW between a same minimum RW and a same maximum RW. In some embodiments, the minimum and maximum RWs may be different from each other by at least 15%, or at least 20%, or at least 25%, or at least 30%, or at least 35%, or at least 40%, or at least 45%, or at least 50%, or at least 55%, or at least 60%, or at least 65%, or at least 70%.

According to some aspects of the present description, an optical film may include at least three, or at least 4, or at least 5, or at least 6, or at least 7, or at least 8, or at least 9, or at least 10 non-overlapping optical packets stacked along a thickness direction (e.g., a z-axis) of the optical film and co-extruded and co-stretched with one another. In some embodiments, each of the at least three optical packets may include a plurality of optical repeat units ORUs. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm and may include at least a polymeric A layer and a different polymer B layer. In some embodiments, the ORUs in the at least three non-overlapping optical packets may be sequentially numbered from a same first major side of the optical film to an opposite second major side of the optical film.

In some embodiments, a scatter plot of a thickness versus the number of the sequentially numbered ORUs in the at least three non-overlapping optical packets may include at least first, second, and third non-overlapping scatter plots of the sequentially numbered ORUs in one-to-one correspondence to the at least three optical packets. In some embodiments, each of the at least first, second, and third non-overlapping scatter plots may include at least 3, or at least 5, or at least 10, or at least 15, or at least 20, or at least 25, or at least 30, or at least 50 of the sequentially numbered ORUs in the plurality of ORUs. In some embodiments, a best linear fit to each of at least two of the at least the first through the third scatter plots may have a slope having a magnitude of greater than about 0.7, or greater than about 1, or greater than about 1.5, or greater than about 2, or greater than about 2.5, or greater than about 3, or greater than about 4, or greater than about 5, or greater than about 6, or greater than about 7, or greater than about 8, or greater than about 9, or greater than about 11, or greater than about 15, or greater than about 18, or greater than about 18.5, or greater than about 19, or greater than about 19.5, or greater than about 20 nm per ORU number.

According to some aspects of the present description, an optical film may include at least three, or at least 4, or at least 5, or at least 6, or at least 7, or at least 8, or at least 9, or at least 10 non-overlapping optical packets stacked along a thickness direction (e.g., a z-axis) of the optical film and co-extruded and co-stretched with one another. In some embodiments, each of the at least three optical packets may include a plurality of optical repeat units ORUs. In some embodiments, each of the ORUs may include at least a polymeric A layer and a different polymer B layer and may have a peak reflectivity at a corresponding resonant wavelength (RW) disposed in a wavelength range from about 200 nm to about 2000 nm, or about 250 nm to about 1500 nm, or about 300 nm to about 1000 nm, or about 350 nm to about 800 nm. In some embodiments, a scatter plot of the RWs versus depths of the ORUs in the at least three optical packets, the depths relative to a same major side of the optical film, may include at least first, second, and third non-overlapping scatter plots of the ORUs. In some embodiments, each of the at least first, second, and third non-overlapping scatter plots may include at least 3, or at least 5, or at least 10, or at least 15, or at least 20, or at least 25, or at least 30, or at least 50 of the ORUs in the plurality of ORUs. In some embodiments, a magnitude of a second-order coefficient of a best second degree polynomial fit to each of at least two of the at least the first through the third scatter plots may have a magnitude of greater than about 0.016, or greater than about 0.018, or greater than about 0.02, or greater than about 0.025, or greater than about 0.03, or greater than about 0.1, or greater than about 0.2, or greater than about 0.3, or greater than about 0.4, or greater than about 0.5, or greater than about 1, or greater than about 2, or greater than about 5, or greater than about 10, or greater than about 15.

According to some aspects of the present description, an optical film may include at least three, or at least 4, or at least 5, or at least 6, or at least 7, or at least 8, or at least 9, or at least 10 non-overlapping optical packets stacked along a thickness direction (e.g., a z-axis) of the optical film and co-extruded and co-stretched with one another. In some embodiments, each of the at least three optical packets may include at least three, or at least 4, or at least 5, or at least 6, or at least 7, or at least 8, or at least 9, or at least 10, or at least 15, or at least 20, or at least 50, or at least 100, or at least 150 optical repeat units ORUs. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm and may include at least a polymeric A layer and a different polymer B layer. In some embodiments, the ORUs in the at least three optical packets may be sequentially numbered from a same first major side of the optical film to an opposite second major side of the optical film.

In some embodiments, a scatter plot of a thickness versus the number of the sequentially numbered ORUs in the at least three optical packets may include at least first, second, and third non-overlapping scatter plots of the sequentially numbered ORUs in one-to-one correspondence to the at least three optical packets. In some embodiments, magnitudes of slopes of best linear fits to at least two of the at least the first through the third scatter plots may be different by at least about 20%, or at least about 30%, or at least about 40%, or at least about 50%, or at least about 75%, or at least about 100%, or at least about 250%, or at least about 500%, or at least about a factor of 5, or at least about a factor of 10, or at least about a factor of 15, or at least about a factor of 20.

According to some aspects of the present description, an optical film may include at least three, or at least 4, or at least 5, or at least 6, or at least 7, or at least 8, or at least 9, or at least 10 non-overlapping optical packets stacked along a thickness direction (e.g., a z-axis) of the optical film and co-extruded and co-stretched with one another. In some embodiments, each of the at least three optical packets comprising at least three, or at least 4, or at least 5, or at least 6, or at least 7, or at least 8, or at least 9, or at least 10, or at least 15, or at least 20, or at least 50, or at least 100, or at least 150 optical repeat units ORUs. In some embodiments, each of the ORUs may include at least a polymeric A layer and a different polymer B layer and may have a peak reflectivity at a corresponding resonant wavelength (RW) disposed in a wavelength range from about 200 nm to about 2000 nm, or about 250 nm to about 1500 nm, or about 300 nm to about 1000 nm, or about 350 nm to about 800 nm.

In some embodiments, a scatter plot of the RWs versus depths of the ORUs in the at least three optical packets, the depths relative to a same major side of the optical film, may include at least first, second, and third non-overlapping scatter plots of the ORUs. In some embodiments, each of the at least first, second, and third non-overlapping scatter plots may include at least 3, or at least 5, or at least 10, or at least 15, or at least 20, or at least 25, or at least 30, or at least 50 of the ORUs in the plurality of ORUs. In some embodiments, magnitudes of second-order coefficients of best second-degree polynomial fits to at least two of the at least the first through the third scatter plots may be different by at least 20%, or at least 30%, or at least 40%, or at least 50%, or at least 75%, or at least 100%, or at least 250%, or at least 500%, or at least a factor of 5, or at least a factor of 10, or at least a factor of 15, or at least a factor of 20, or at least a factor of 50, or at least a factor of 100, or at least a factor of 500, or at least a factor of 1000.

According to some aspects of the present description, an optical film may include at least three, or at least 4, or at least 5, or at least 6, or at least 7, or at least 8, or at least 9, or at least 10 non-overlapping optical packets stacked along a thickness direction (e.g., z-axis) of the optical film and co-extruded and co-stretched with one another. In some embodiments, each of the at least three optical packets may include at least three, or at least 4, or at least 5, or at least 6, or at least 7, or at least 8, or at least 9, or at least 10, or at least 15, or at least 20, or at least 50, or at least 100, or at least 150 optical repeat units ORUs. In some embodiments, each of the ORUs may include at least a polymeric A layer and a different polymer B layer and may have a peak reflectivity at a corresponding resonant wavelength (RW) disposed in a wavelength range from about 200 nm to about 2000 nm, or about 250 nm to about 1500 nm, or about 300 nm to about 1000 nm, or about 350 nm to about 800 nm.

In some embodiments, a plot of the RWs versus depths of the ORUs in the at least three optical packets, the depths relative to a same major side of the optical film, may include at least first, second, and third non-overlapping plots of the ORUs. In some embodiments, each of the at least first, second, and third non-overlapping plots including at least 3, or at least 5, or at least 10, or at least 15, or at least 20, or at least 25, or at least 30, or at least 50 of the ORUs in the plurality of ORUs and may have a slope defined a rate of change of the RW with respect to the depth at a same first RW. In some embodiments, magnitudes of the slopes of at least two of the at least the first through the third plots may be different by at least 20%, or at least 30%, or at least 40%, or at least 50%, or at least 75%, or at least 100%, or at least 250%, or at least 500%, or at least a factor of 5, or at least a factor of 10, or at least a factor of 15, or at least a factor of 20.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm and may include at least a polymeric A layer and a different polymer B layer.

In some embodiments, for at least first, second, and third ORU thicknesses may be different from each other by at least 10 nm, or at least 15 nm, or at least 20 nm, or at least 30 nm, or at least 40 nm, or at least 50 nm, or at least 60 nm, or at least 70 nm, or at least 80 nm, or at least 90 nm, or at least 100 nm. In some embodiments, the optical film may include at least three first ORUs, at least three second ORUs, and at least three third ORUs that have thicknesses within 20%, or within 15%, or within 10%, or within 5%, or within 2.5%, within or 1% of the respective first, second, and third ORU thicknesses. In some embodiments, for each of the at least three first ORUs, the at least three second ORUs, and the at least three third ORUs, the ORUs may be spaced apart along a thickness direction (e.g., a z-axis) of the optical film by at least 2 microns, or at least 3 microns, or at least 4 microns, or at least 5 microns, or at least 6 microns, or at least 7 microns, or at least 8 microns, or at least 9 microns, or at least 10 microns, or at least 12 microns, or at least 15 microns, or at least 17 microns, or at least 20 microns.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may include at least a polymeric A layer and a different polymer B layer.

In some embodiments, for a substantially collimated light incident on the optical film at a first incident angle, for at least one polarization state (e.g., a p-polarization type), and for at least first blue, first green, and first red wavelengths in respective blue, green, and red wavelength ranges extending from about respective 420 nm, 490 nm, and 590 nm to about respective 480 nm, 560 nm, and 670 nm, the optical film may include at least three blue ORUs, at least three green ORUs, and at least three red ORUs that have resonant wavelengths within 20%, or within 15%, or within 10%, or within 5%, or within 2.5%, or within 1% of the respective first blue, green and red wavelengths. In some embodiments, for each of the at least three blue ORUs, the at least three green ORUs, and the at least three red ORUs, the ORUs may be spaced apart along a thickness direction (e.g., the z-axis) of the optical film by at least 2 microns, or at least 3 microns, or at least 4 microns, or at least 5 microns, or at least 6 microns, or at least 7 microns, or at least 8 microns, or at least 9 microns, or at least 10 microns, or at least 12 microns, or at least 15 microns, or at least 17 microns, or at least 20 microns.

According to some aspects of the present description, an optical film may include a plurality of optical repeat units (ORUs) co-extruded and co-stretched with one another and numbering at least 10, or at least 25, or at least 50, or at least 100, or at least 150, or at least 200, or at least 250, or at least 300, or at least 350, or at least 400, or at least 450, or at least 500 in total. In some embodiments, each of the ORUs may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm and may include at least a polymeric A layer and a different polymer B layer. In some embodiments, the ORUs in the plurality of the ORUs may be sequentially numbered from a same first major side of the optical film to an opposite second major side of the optical film.

In some embodiments, a scatter plot of the average thicknesses versus the numbers of the sequentially numbered ORUs in the plurality of the optical packets may include at least three non-overlapping groups of the ORUs. In some embodiments, each of the groups may include at least 3, or at least 5, or at least 10, or at least 15, or at least 20, or at least 25, or at least 30, or at least 50 of the sequentially numbered ORUs in the plurality of ORUs. In some embodiments, for each pair of adjacent first and second groups in the plurality of the groups, the first group may include a first ORU closest to the second group and the second group may include a second ORU closest to the first group, wherein the thicknesses of the first and second ORUs are different by at least 20%, or at least 30%, or at least 40%, or at least 50%, or at least 60%, or at least 70%, or at least 80%, or at least 90%, or at least 100%.

In some embodiments, for a substantially collimated light incident on the optical film at a first incident angle, for at least one polarization state (e.g., a p-polarization type), and for at least a first wavelength in a visible wavelength range extending from about 420 nm to about 680 nm, the plurality of the ORUs and at least one of the groups in the at least three non-overlapping groups, may have respective optical reflectances R and R1, wherein R>R1>15%, or greater than 20%, or greater than 25%, or greater than 30%, or greater than 35%, or greater than 40%, or greater than 45%, or greater than 50%, and R/R1≥1.1, or greater than or equal to 1.2, or greater than or equal to 1.3, or greater than or equal to 1.4, or greater than or equal to 1.5, or greater than or equal to 2, or greater than or equal to 3, or greater than or equal to 4, or greater than or equal to 5, or greater than or equal to 6, or greater than or equal to 7, or greater than or equal to 8, or greater than or equal to 9, or greater than or equal to 10, or greater than or equal to 15, or greater than or equal to 20.

According to some aspects of the present description, an optical film may include a plurality of polymeric layers stacked along a thickness direction (e.g., a z-axis) of the optical film. In some embodiments, each of the polymeric layers may have an average thickness of less than about 500 nm, or less than about 450 nm, or less than about 400 nm, or less than about 350 nm, or less than about 300 nm, or less than about 250 nm, or less than about 200 nm, or less than about 150 nm, such that when an optical light ray having a first visible wavelength in a visible wavelength range extending from about 420 nm to about 680 nm is incident on the plurality of polymeric layers at a first incident angle of at least 10 degrees, or at least 15 degrees, or at least 20 degrees, or at least 25 degrees, or at least 30 degrees, or at least 35 degrees, or at least 40 degrees, or at least 45 degrees, the plurality of polymeric layers may reflect the incident light as a reflected light including a plurality of spaced apart substantially parallel reflected light rays. In some embodiments, each of the reflected light rays may have the first visible wavelength. In some embodiments, a separation between at least two adjacent reflected light rays in the plurality of reflected light rays may be greater than an average total thickness of at least 10, or at least 20, or at least 30, or at least 40, or at least 50, or at least 60, or at least 70, or at least 80, or at least 90, or at least 100 sequentially stacked polymeric layers in the plurality of polymeric layers.

In some embodiments, the polymeric layers in the plurality of polymeric layers may have a total thickness S4, wherein the reflected light rays include at least one middle light ray disposed between first and second end light rays, and wherein a separation S3 between the first and second end light rays is less than about 2S4, or less than about 1.9S4, or less than about 1.8S4, or less than about 1.7S4, or less than about 1.6 S4, or less than about 1.5S4, or less than about 1.4S4.

According to some aspects of the present description, an optical film may include a plurality of polymeric layers stacked along a thickness direction (e.g., a z-axis) of the optical film. In some embodiments, when a substantially monochromatic light ray having an optical intensity Ii is incident on the plurality of polymeric layers at a first incident angle of at least 5 degrees, or at least 10 degrees, or at least 15 degrees, or at least 20 degrees, or at least 25 degrees, or at least 30 degrees, or at least 35 degrees, or at least 40 degrees, or at least 45 degrees, the plurality of polymeric layers may reflect the incident light ray as at least two spaced apart reflected light rays having corresponding at least two optical intensities Ira and Irb. In some embodiments, each of ratios Ira/Ii and Irb/Ii may be greater than about 0.1, or greater than about 0.15, or greater than about 0.20, or greater than about 0.25, or greater than about 0.3, or greater than about 0.35, or greater than about 0.4, or greater than about 0.45, or greater than about 0.5. In some embodiments, at least one of the ratios Ira/li and Irb/Ii may be less than about 0.9, or less than about 0.85, or less than about 0.8, or less than about 0.75, or less than about 0.7, or less than about 0.65, or less than about 0.6, or less than about 0.55, or less than about 0.5.

According to some aspects of the present description, an optical system includes a display, at least one optical component (e.g., an optical lens) having chromatic dispersion, and an optical film having a plurality of polymeric layers and configured to at least partially compensate for the chromatic dispersion of the at least one optical component.

In some embodiments, the display may be configured to form and emit an image including coincident first and second emitted image rays having respective first (e.g., blue) and second (e.g., red) wavelengths at least about 20 nm, or at least about 50 nm, or at least about 75 nm, or at least about 100 nm, or at least about 125 nm, or at least about 150 nm, or at least about 175 nm, or at least about 200 nm apart. In some embodiments, the first and second wavelengths may be within a visible wavelength range extending from about 420 nm to about 680 nm. In some embodiments, the optical system may be configured to display a virtual image of the emitted image to a viewer.

In some embodiments, an optical interaction between the at least one optical component and the coincident first and second emitted image rays laterally separates the first and second emitted image rays so that, when incident on the optical film, the first and second emitted image rays may have respective optical intensities I1 and I2 and may be separated by a first distance P1. In some embodiments, the optical film may reflect the incident first and second emitted image rays as respective reflected first and second image rays having respective optical intensities Q1 and Q2 and separated by a second distance P2. In some embodiments, Q1/I1≥0.15, or greater than or equal to 0.2, or greater than or equal to 0.3, or greater than or equal to 0.4. In some embodiments, Q2/I2≥0.15, or greater than or equal to 0.2, or greater than or equal to 0.3, or greater than or equal to 0.4. In some embodiments, P2 may be less than P1 by at least 10%, or at least 20%, or at least 50%, or at least a factor of 2, or at least a factor of 2.5, or at least a factor of 3, or at least a factor of 5, or at least a factor of 10, or at least a factor of 50, or at least a factor of 100.

In some embodiments, the optical film may include a reflective polarizer, such that for a substantially normally incident light, the reflective polarizer may reflect at least 60%, or at least 65%, or at least 70%, or at least 75%, or at least 80%, or at least 85%, or at least 90% of the incident light polarized along a first in-plane direction (e.g., polarized along an x-axis of the film, or a “block axis”) and may transmit at least 60%, or at least 65%, or at least 70%, or at least 75%, or at least 80%, or at least 85%, or at least 90% of the incident light polarized along an orthogonal second in-plane direction (e.g., polarized along a y-axis of the film, or a “pass axis”).

In some embodiments, the optical system may further include a partial reflector, such that for a substantially normally incident light and for each of mutually orthogonal polarization states (e.g., the x-axis and y-axis of the partial reflector), the partial reflector may reflect at least 30%, or at least 35%, or at least 40%, or at least 45% of the incident light and may transmit at least 30%, or at least 35%, or at least 40%, or at least 45% of the incident light. In some embodiments, the optical system may further include a retarder layer configured to change a phase of a normally incident light having the first or second wavelengths by at least 20 degrees, or at least 25 degrees, or at least 30 degrees, or at least 35 degrees, or at least 40 degrees, or at least 45 degrees.

In some embodiments, the optical system may further include an absorbing polarizer, such that for a substantially normally incident light, the absorbing polarizer may absorb at least 60%, or at least 55%, or at least 70%, or at least 75%, or at least 80%, or at least 85%, or at least 90% of the incident light polarized along a first in-plane direction (e.g., the x-axis of the absorbing polarizer) and may transmit at least 60%, or at least 55%, or at least 70%, or at least 75%, or at least 80%, or at least 85%, or at least 90% of the incident light polarized along an orthogonal second in-plane direction (e.g., the y-axis of the absorbing polarizer).

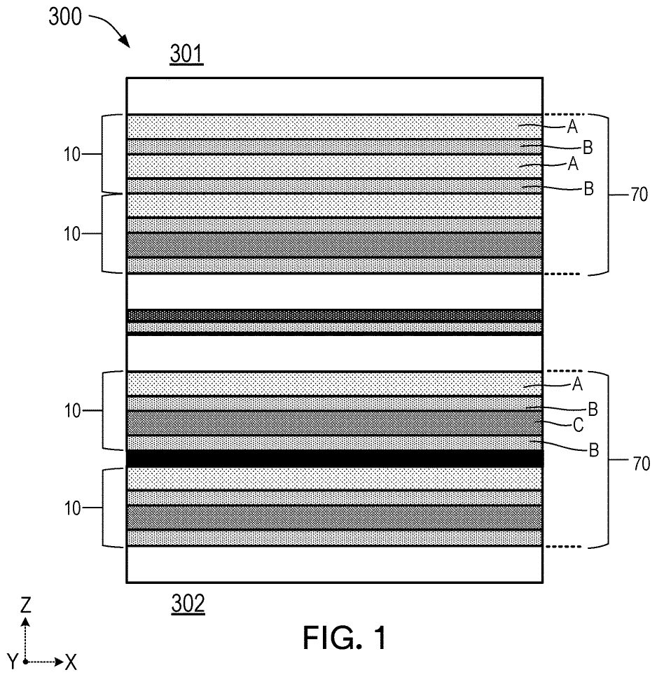

Turning now to the figures, FIG. 1 is a side view of an embodiment of an optical film having a plurality of optical repeat units (ORUs), according to the present description. In some embodiments, optical film 300 may include a plurality of optical repeat units (ORUs) 10 which are co-extruded and co-stretched with one another. In some embodiments, each ORU may have an average thickness of less than about 1500 nm, or less than about 1250 nm, or less than about 1000 nm, or less than about 900 nm, or less than about 800 nm, or less than about 700 nm, or less than about 600 nm, or less than about 500 nm, or less than about 400 nm, or less than about 300 nm, or less than about 200 nm. In some embodiments, each ORU 10 may include at least a polymeric A layer and a different polymeric B layer, or a plurality of alternating pairs of polymeric A layers and polymeric B layers. In some embodiments, at least some of the polymeric A layers may have different indices of refraction than at least some of the polymeric B layers. In some embodiments, controlling the thickness profiles, indices of refraction, number, and arrangement of each ORU 10 may be used to “tune” the ORU 10 to exhibit a specific optical characteristic. In some embodiments, the number of ORUs 10 may be at least 10, or at least 25, or at least 50, or at least 100, or at least 150, or at least 200, or at least 250, or at least 300, or at least 350, or at least 400, or at least 450, or at least 500 in total. In some embodiments, the ORUs 10 may be sequentially numbered from the first major side 301 of optical film 300 to an opposite, second major side 302 of the optical film 300. In some embodiments, optical film 300 may be a reflective polarizer.

In some embodiments, optical film 300 may include at least 3, or at least 4, or at least 5, or at least 6, or at least 7, or at least 8, or at least 9, or at least 10 non-overlapping optical packets 70 stacked along a thickness direction of the optical film (e.g., the z-axis indicated in FIG. 1). In some embodiments, optical packets 70 may be co-extruded and co-stretched with one another. In some embodiments, each of the optical packets 70 may include a plurality of optical repeat units, such as ORUs 10 described above and elsewhere herein.

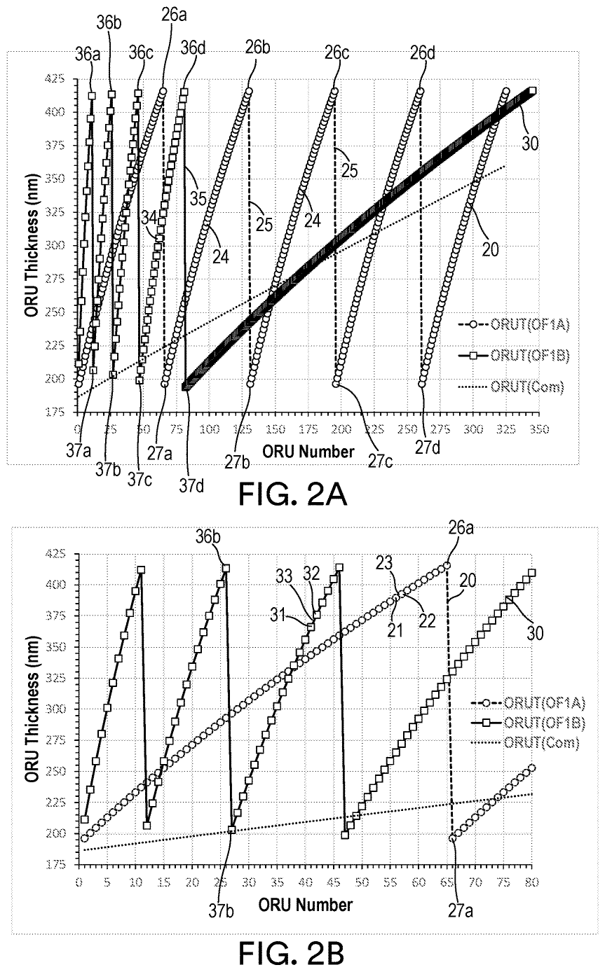

FIGS. 2A and 2B provide scatter plots of thicknesses versus the numbers of the ORUs for one embodiment of an optical film, such as optical film 300 shown in FIG. 1. FIGS. 2A and 2B will be referenced together in the following description. FIG. 2B shows the same data as FIG. 2A except that it shows a more detailed representation, focusing on the range of ORU numbers between 1 and about 80.

FIGS. 2A and 2B show scatter plots 20 and 30 representing scatter plots of ORU thickness versus ORU number for two different optical films/optical packets. Looking at both figures, when adjacent data points (e.g., 21, 22; or 31, 32 shown in FIG. 2B) in scatter plots 20, 30 are connected with straight line segments (e.g., line segments 23, 33) to form a continuous line plot, then the continuous line plot 20, 30 comprises a plurality of first lines 24, 34 where the ORU thickness in all of the first lines 24, 34 substantially increases with a same one of increasing and decreasing ORU number (in the embodiment shown in FIGS. 2A/2B, increasing), alternating with, and intersecting, a plurality of second lines 25, 35 where the ORU thickness in all of the second lines 25, 35 substantially decreases with the same one of increasing and decreasing ORU number. In some embodiments, the intersection points (between first lines 24, 34 and second lines 25, 35) form at least three peaks 26a-26d, 36a-36d alternating with at least two valleys 27a-27d, 37a-37d.

As shown in the examples and embodiments discussed herein, ORU thickness within each first line 24, 34 increases with increasing ORU number. However, in other embodiments, it is possible that the ORU thicknesses in each first line 24, 34 increases with decreasing ORU number.

In some embodiments, at least two of the first lines 24, 34 in the plurality of the first lines are substantially parallel. For example, the two first lines 24 explicitly labeled as “24” in FIG. 2A are substantially parallel. In some embodiments, at least two of the second lines 25, 35 in the plurality of the second lines 25, 35 are substantially parallel. For example, the two second lines 25 explicitly labeled as “25” in FIG. 2A are substantially parallel.

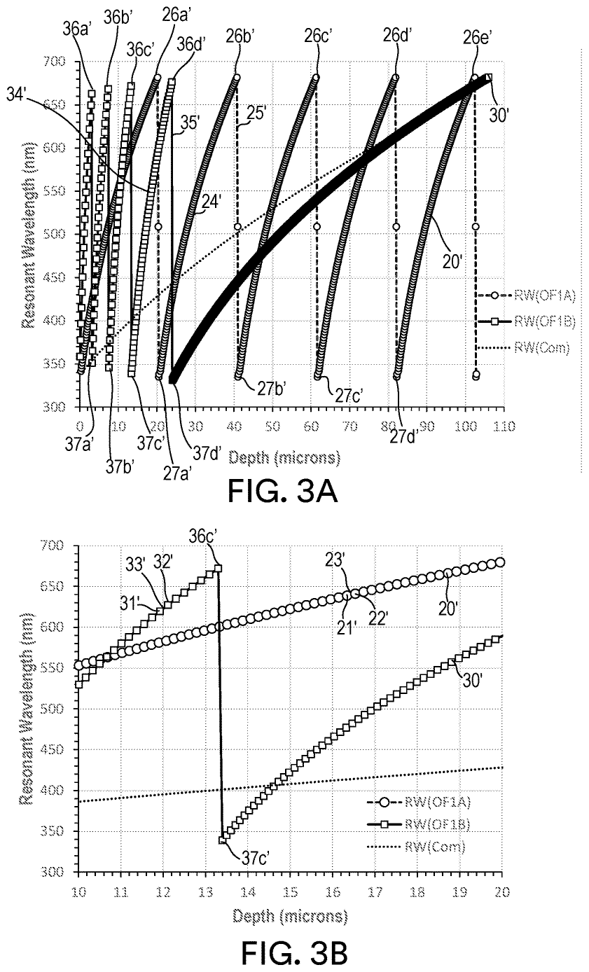

FIGS. 3A and 3B provide scatter plots of the resonant wavelengths of the ORUs versus the depths of the ORUs in an embodiment of an optical film, such as optical film 300 of FIG. 1. FIGS. 3A and 3B will be referenced together in the following description. FIG. 3B shows the same data as FIG. 3A except that it shows a more detailed representation, focusing on the range of ORU depths of the ORUs between 1 and about 20 microns. Data is shown for two optical films/optical stacks 20′ and 30′.

FIGS. 3A and 3B show scatter plots 20′, 30′ of the resonant wavelengths (RWs) of the ORUs versus depths of the ORUs in microns relative to the same major side (e.g., side 301 shown in FIG. 1) of optical film 300. As shown in the embodiment of these figures, when adjacent data points 21′, 22′ of plot 20′ and adjacent points 31′, 32′ of plot 30′ (see, e.g., FIG. 3B) are connected with straight line segments 23′, 33′ to form continuous line plots, then the continuous line plots 20′, 30′ include a plurality of first lines 24′, 34′ where the ORU RW in all of the first lines substantially increases with a same one of increasing and decreasing ORU depth (e.g., increasing, as shown in this particular example), alternating with, and intersecting, a plurality of second lines 25′, 35′ where the ORU RW in all of the second lines decreases with the same one of increasing and decreasing ORU depth (again, in this example, increasing). In some embodiments, the intersection points between first lines form at least three peaks 26a′-26e′ and 36a′-36d′ alternating with at least two valleys 27a′-27d′ and 37a′-37d′.

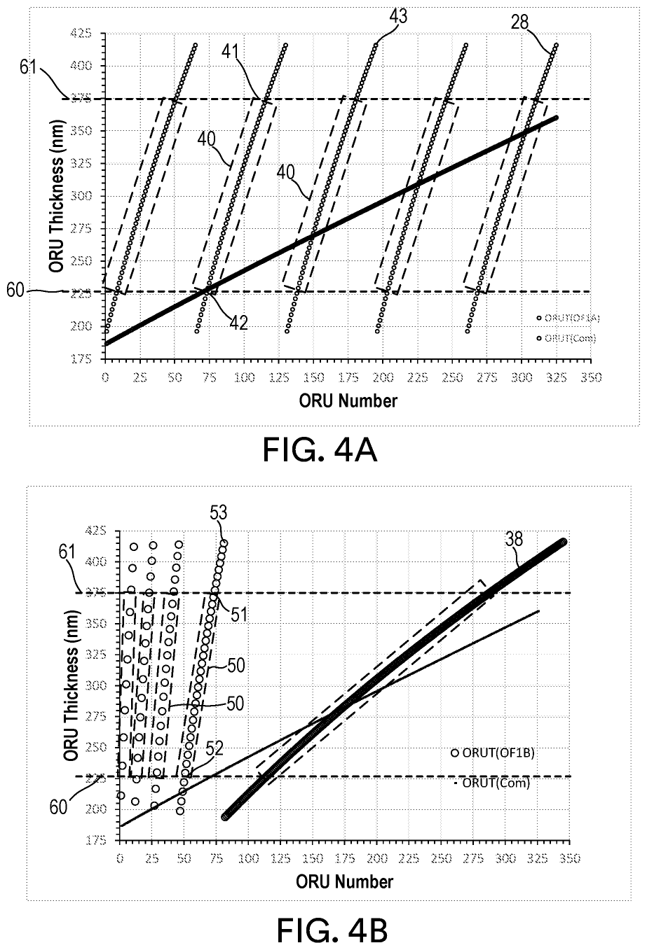

FIGS. 4A and 4B provide alternate scatter plots of thicknesses versus the numbers of the ORUs for an optical film, such as optical film 300 of FIG. 1. FIGS. 4A and 4B will be referenced together in the following description. FIG. 4A provides a scatter plot 28 for a first optical film/optical stack (OF1A) and FIG. 4B provides scatter plot 38 for a second optical film/optical stack (OF1B).

Looking at FIGS. 4A and 4B, scatter plots 28, 38 showing the thicknesses versus the numbers of the ORUs include at least three non-overlapping groups 40, 50 of the ORUs. In some embodiments, adjacent groups in the at least three groups 40, 50 may be separated from each other by at least one of the ORUs 43, 53 not in any of the at least three groups 40, 50. In the embodiment shown, each of the groups include at least 3, or at least 5, or at least 10, or at least 15, or at least 20, or at least 25, or at least 30, or at least 50 of the sequentially numbered ORUs in the plurality of ORUs including first ORUs 41, 51 and second ORUs 42, 52 ORUs having respective maximum 61 and minimum 60 thicknesses among the at least three ORUs in the group. The minimum 60 and maximum 61 thicknesses in the group may differ from each other by at least 15%, or at least 20%, or at least 25%, or at least 30%, or at least 35%, or at least 40%, or at least 45%, or at least 50%, or at least 55%, or at least 60%, or at least 65%, or at least 70% (e.g., the percent change from the minimum thickness 60 in groups 40, 50, which is 225 nm, to the maximum thickness 61 in these groups, which is 375 nm, is about 67%). In this embodiment (FIGS. 4A and 4B), for each of first ORUs 41, 51 and second ORUs 42, 52 in the at least three non-overlapping groups 40, 50 of the ORUs, the thicknesses of the ORUs may be within about 10% of each other (e.g., for group 40 the thicknesses differ by less than about 1%; for group 50 the thicknesses differ by about 4.4%).

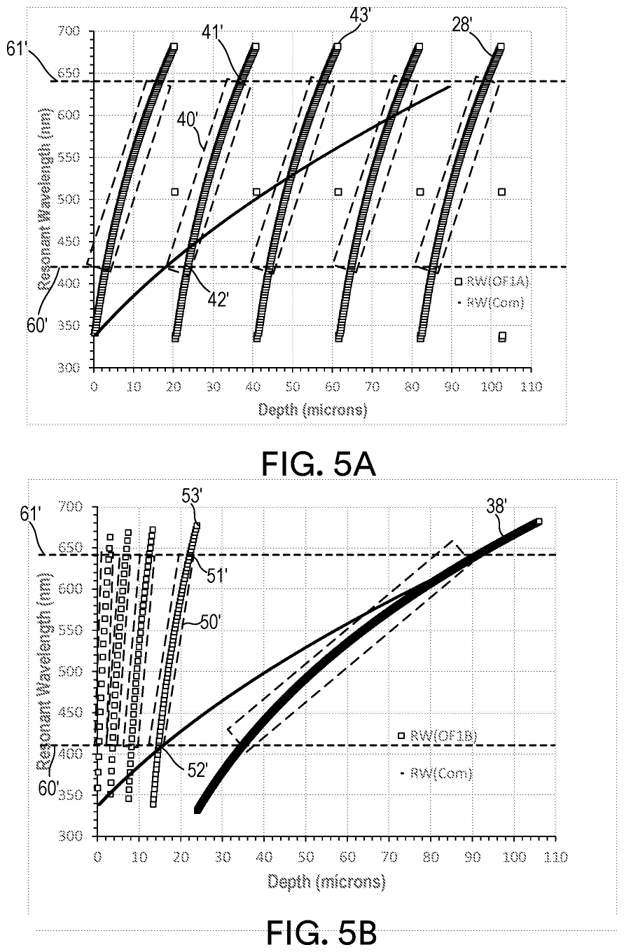

FIGS. 5A and 5B provide alternate scatter plots of the resonant wavelengths (RWs) of the ORUs versus the depths of the ORUs for an optical film, such as optical film 300 of FIG. 1. FIGS. 5A and 5B will be referenced together in the following description. FIG. 5A provides a scatter plot 28′ for a first optical film/optical stack (OF1A) and FIG. 5B provides scatter plot 38′ for a second optical film/optical stack (OF1B).

Scatter plot 28′, 38′ of the RWs of the ORUs versus depths of the ORUs (the depths relative to a same major side (such as first major side 301 of FIG. 1, or, alternately, second major side 302) of the optical film include at least three non-overlapping groups 40′, 50′ of the ORUs. In some embodiments, adjacent groups in the at least three groups 40′, 50′ may be separated from each other by at least one of the ORUs 43′, 53′ not in any of the at least three groups 40′, 50′.

In some embodiments, each of the groups may include at least 3, or at least 5, or at least 10, or at least 15, or at least 20, or at least 25, or at least 30, or at least 50 of the sequentially numbered ORUs in the plurality of ORUs. The ORUs may include first ORUs 41′, 51′ and second ORUs 42′, 52′ having respective maximum and minimum RWs among the at least three ORUs in the group. For example, as shown in FIGS. 5A and 5B, the minimum RW is 420 nm (line 60′) and the maximum RW is 640 nm (line 61′). In some embodiments, the minimum and maximum RWs in the group may differ from each other by at least 15%, or at least 20%, or at least 25%, or at least 30%, or at least 35%, or at least 40%, or at least 45%, or at least 50%, or at least 55%, or at least 60%, or at least 65%, or at least 70% (that is, the percent change from the minimum RW of 420 nm to the maximum RW of 640 nm, shown for both groups 40′ and 50′ is about 52.4%. In some embodiments, for each of the first ORUs 41′, 51′ and the second ORUs 42′, 52′ in the at least three non-overlapping groups 40′, 50′ of the ORUs, the RWs of the ORUs may be within about 10% of each other.

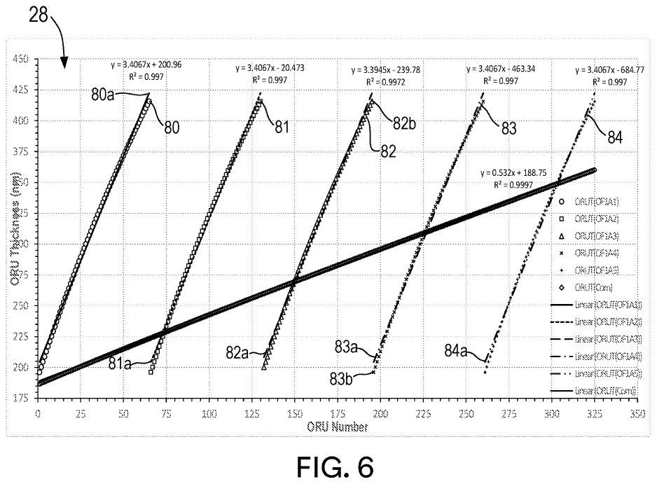

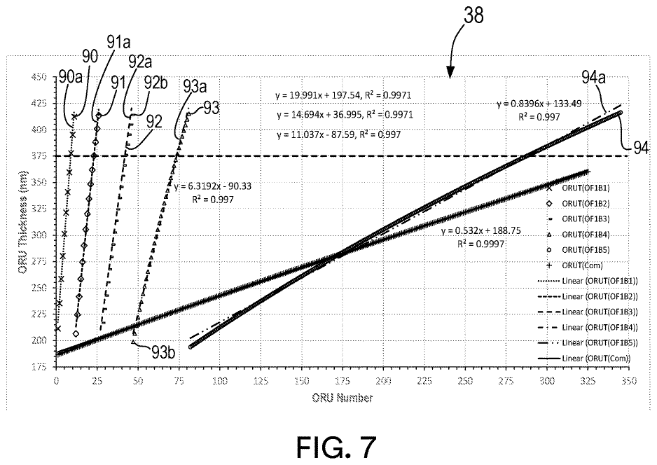

FIGS. 6 and 7 provide additional details on the scatter plots 28, 38 of FIGS. 4A and 4B respectively, plotting thicknesses versus the numbers of the ORUs for an optical film (e.g., optical film 300 of FIG. 1). FIGS. 6 and 7 will be referenced together in the following description. FIG. 6 provides a scatter plot 28 for a first optical film/optical stack (OF1A) and FIG. 7 provides scatter plot 38 for a second optical film/optical stack (OF1B).

In this embodiment, scatter plots 28, 38 plotting ORU thickness versus the number of the sequentially numbered ORUs in the at least three non-overlapping optical packets (e.g., optical packets 40, 50 of FIGS. 4A and 4B) include at least first 80, 90, second 81, 91, and third 84, 94 non-overlapping scatter plots 80-84, 90-94 of the sequentially numbered ORUs in one-to-one correspondence to the at least three optical packets 40, 50. Each of the at least first 80, 90, second 81, 91, and third 84, 94 non-overlapping scatter plots including at least 3, or at least 5, or at least 10, or at least 15, or at least 20, or at least 25, or at least 30, or at least 50 of the sequentially numbered ORUs in the plurality of ORUs.

In the embodiments shown, a best linear fit 80a-84a, 90a-94a to each of at least two of the at least the first through the third scatter plots has a slope having a magnitude of greater than about 0.7 nm, or greater than about 1 nm, or greater than about 1.5 nm, or greater than about 2 nm, or greater than about 2.5 nm, or greater than about 3 nm, or greater than about 5 nm, or greater than about 7 nm, or greater than about 10 nm, or greater than about 12 nm, or greater than about 15 nm, or greater than about 16 nm, or greater than about 18 nm, or greater than about 18.5 nm, or greater than about 19 nm, or greater than about 19.5 nm, or greater than about 20 nm per ORU number.

Looking now at adjacent groups 82 and 83 (FIG. 6) and 92 and 93 (FIG. 7), each pair of adjacent first groups 82, 92 and second groups 83, 93 in the plurality of the groups, the first group 82, 92 includes a first ORU 82b, 92b closest to the second group 83, 93 and the second group 83, 93 includes a second ORU 83b, 93b closest to the first group, wherein the thicknesses of the first ORUs 82b, 92b and second ORUs 83b, 93b are different by at least 20%, or at least 30%, or at least 40%, or at least 50%, or at least 60%, or at least 70%, or at least 80%, or at least 90%, or at least 100%.

Looking now at FIG. 7, scatter plot 38 of thickness versus the number of the sequentially numbered ORUs in the at least three optical packets includes at least first 90, second 91, and third 94 non-overlapping scatter plots 90-94 of the sequentially numbered ORUs in one-to-one correspondence to the at least three optical packets (such as optical packets 40, 50 of FIGS. 4A and 4B). In some embodiments, magnitudes of slopes of best linear fits 90a-94a to at least two of the at least the first through the third scatter plots are different by at least about 20%, or at least about 30%, or at least about 40%, or at least about 50%, or at least about 75%, or at least about 100%, or at least about 250%, or at least about 500%, or at least about a factor of 5, or at least about a factor of 10, or at least about a factor of 15, or at least about a factor of 20.

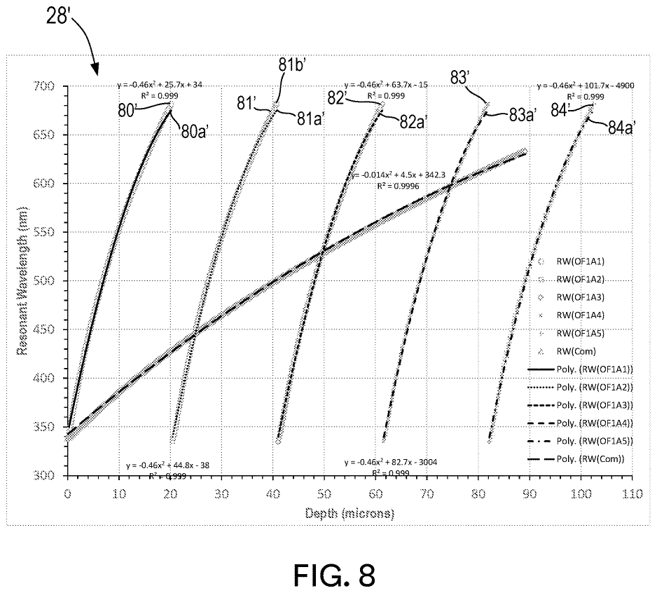

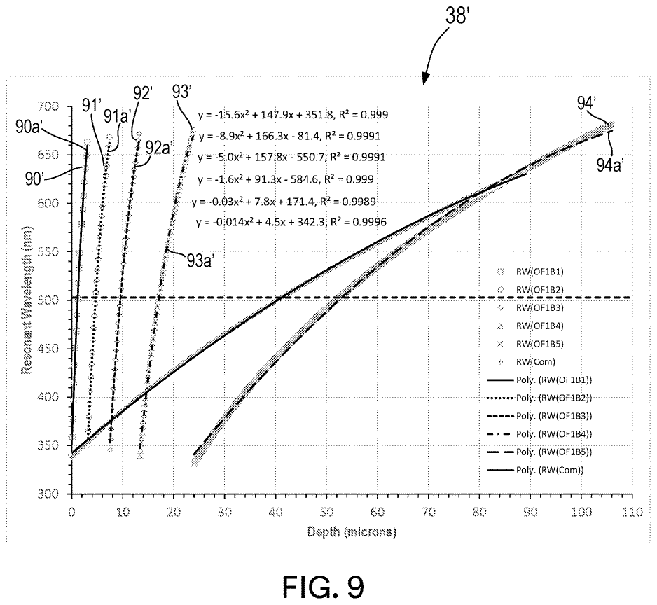

FIGS. 8 and 9 provide additional details on the scatter plots 28′, 38′ of FIGS. 5A and 5B respectively, plotting resonant wavelengths (RWs) in nanometers (nm) versus the depth of the ORUs in microns for an optical film (e.g., optical film 300 of FIG. 1). FIGS. 8 and 9 will be referenced together in the following description. FIG. 8 provides a scatter plot 28′ for a first optical film/optical stack (OF1A) and FIG. 9 provides scatter plot 38′ for a second optical film/optical stack (OF1B).

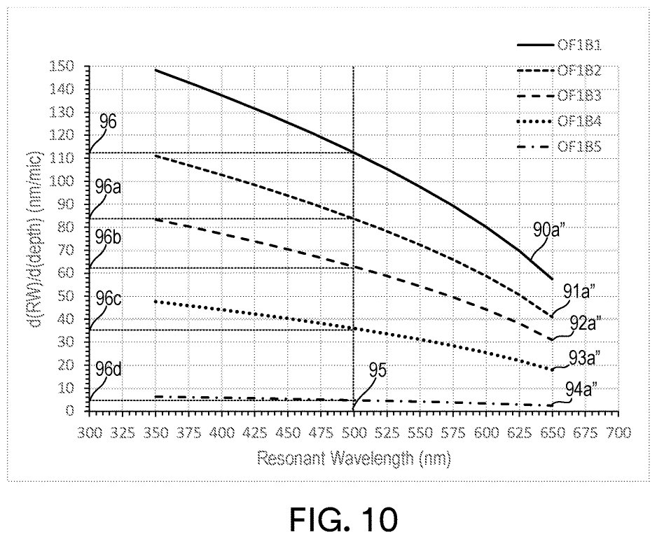

Scatter plot 28′, 38′ of the RWs versus depths of the ORUs in at least three optical packets (the depths relative to a same major side of the optical film, such as first major side 301 or second major side 302, as shown in FIG. 10). Plots 28′, 38′ include at least first 80′, 90′, second 81′, 91′, and third 84′, 94′ non-overlapping scatter plots 80′-84′, 90′-94′ of the ORUs. In some embodiments, each of the at least first 80′, 90′, second 81′, 91′, and third 84′, 94′ non-overlapping scatter plots including at least 3, or at least 5, or at least 10, or at least 15, or at least 20, or at least 25, or at least 30, or at least 50 of the ORUs in the plurality of ORUs. In some embodiments, a magnitude of a second-order coefficient of a best second degree polynomial fit 80a′-84a′, 90a′-94a′ to each of at least two of the at least the first through the third scatter plots has a magnitude of greater than about 0.016, or greater than about 0.018, or greater than about 0.02, or greater than about 0.025, or greater than about 0.03, or greater than about 0.1, or greater than about 0.2, or greater than about 0.3, or greater than about 0.4, or greater than about 0.5, or greater than about 1, or greater than about 2, or greater than about 5, or greater than about 10, or greater than about 15.

In some embodiments, scatter plot 38′ (FIG. 9) of the RWs versus depths of the ORUs in the at least three optical packets, the depths relative to a same major side (e.g., major side 301 or 302) of the optical film, include at least first 90′, second 91′, and third 94′ non-overlapping scatter plots 90′-94′ of the ORUs. In some embodiments, magnitudes of second-order coefficients of best second-degree polynomial fits 90a′-94a′ to at least two of the at least the first through the third scatter plots are different by at least 20%, or at least 30%, or at least 40%, or at least 50%, or at least 75%, or at least 100%, or at least 250%, or at least 500%, or at least a factor of 5, or at least a factor of 10, or at least a factor of 15, or at least a factor of 20, or at least a factor of 50, or at least a factor of 100, or at least a factor of 500, or at least a factor of 1000.

FIG. 10 provides a plot of the rate of change of the resonant wavelength with respect to the depth at a same first resonant wavelength for an embodiment of an optical film, such as optical film 300 of FIG. 1. FIG. 9, discussed elsewhere herein, presented a plot 38′ of the resonant wavelengths (RWs) versus depths of the ORUs in the at least three optical packets, the depths relative to a same major side of an optical film, which included at least first 90′, second 91′, and third 94′ non-overlapping plots 90′-94′ of the ORUs.

Turning to FIG. 10, each of the at least first 90′, second 91′, and third 94′ non-overlapping plots have slopes 90a″-94a″ defined as a rate of change of the RW with respect to the depth (d(RW)/d(depth)). In some embodiments, each of the at least first 90′, second 91′, and third 94′ non-overlapping plots have slopes 96-96d defined at a same first RW 95 (e.g., an RW of 500 nm, as shown in FIG. 10).

In the embodiment shown in FIGS. 9 and 10, magnitudes 96-96d of the slopes of at least two of the at least the first through the third plots defined at first RW 95 may be different by at least 20%, or at least 30%, or at least 40%, or at least 50%, or at least 75%, or at least 100%, or at least 250%, or at least 500%, or at least a factor of 5, or at least a factor of 10, or at least a factor of 15, or at least a factor of 20. For example, magnitude 96 of slope 90a″ at RW 95 is approximately 112, magnitude 96a of slope 91a″ at RW 95 is approximately 84, magnitude 96b of slope 92a″ at RW 95 is approximately 62, magnitude 96c of slope 93a″ at RW 95 is approximately 35, and magnitude 96d of slope 94a″ at RW 95 is approximately 4.

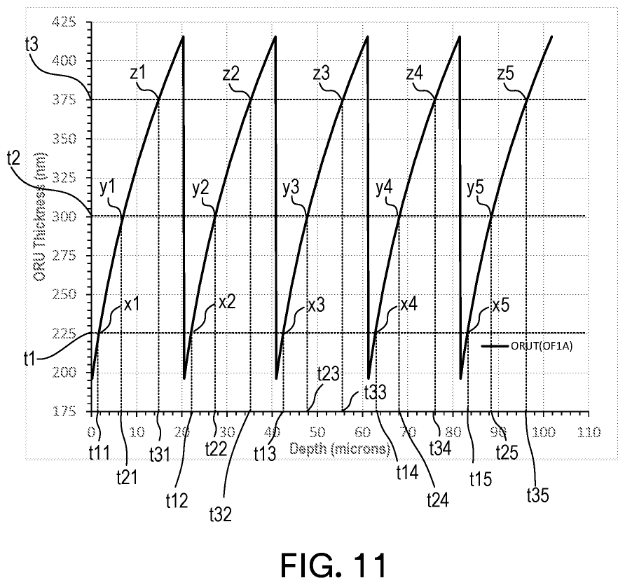

FIG. 11 provided a scatter plot of thicknesses versus the depths of the ORUs for an optical film, such as optical film 300 of FIG. 1. As shown in FIG. 11, for at least first ORU thickness t1 (e.g., 225 nm), second ORU thickness t2 (e.g., 300 nm), and third ORU thickness t3 (e.g., 375 nm), the ORU thicknesses t1, t2, and t3 being different from each other by at least 10 nm, or at least 15 nm, or at least 20 nm, or at least 30 nm, or at least 40 nm, or at least 50 nm, or at least 60 nm, or at least 70 nm, or at least 80 nm, or at least 90 nm, or at least 100 nm, the optical film scatter plot includes at least three first ORUs x1-x5, at least three second ORUs y1-y5, and at least three third ORUs z1-z5 that have thicknesses at least 20%, or at least 15%, or at least 10%, or at least 5%, or at least 2.5%, or at least 1% of the respective first t1, second t2, and third t3 ORU thicknesses. In some embodiments, for each of the at least three first ORUs x1-x5, the at least three second ORUs y1-y5, and the at least three third ORUs z1-z3, the ORUs are spaced apart along a thickness direction (e.g., the z-axis indicated in FIG. 1) of the optical film 300 by at least 2 microns, or at least 3 microns, or at least 4 microns, or at least 5 microns, or at least 6 microns, or at least 7 microns, or at least 8 microns, or at least 9 microns, or at least 10 microns, or at least 12 microns, or at least 15 microns, or at least 17 microns, or at least 20 microns. Stated another way, the ORUs (e.g., each of the at least three first ORUs x1, x2, x3, x4, and x5) are spaced apart in the thickness direction (corresponding to the depth in microns shown on the x-axis of FIG. 11). For example, x1 is shown at depth t11 (about 2 microns), x2 is shown at depth t12 (about 22 microns), x3 is shown at depth t13 (about 43 microns), x4 is shown at depth t14 (about 64 microns), and x5 is shown at depth t15 (about 84 microns). Similar spacings are shown for second ORUs y1-y5 and third ORUs z1-z5.

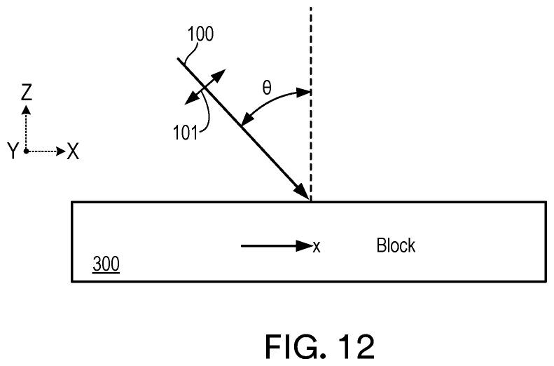

FIG. 12 is provided for illustration purposes and shows a schematic of a substantially collimated light incident on optical film at a first incident angle. FIG. 12 shows a side, schematic view of optical film 300 (e.g., optical film 300 of FIG. 1). A substantially collimated light 100 is incident on optical film 300 and a first incident angle, θ. It should be noted that the optical characteristics of optical film 300 can vary based on the angle of incidence of incident light, as well as the polarization type. Optical film 300 can be configured to substantially reflect light, substantially transmit light, or reflect some portion of the light and transmit another portion of the light, by configuring the number of optical repeat units (ORUs), number and type of alternating polymeric layers within each ORU, the thickness profile of the layers within the ORUs, etc.

For example, as shown in FIG. 12, a substantially collimated light 100 may be incident on optical film 300 at a first incident angle θ and may exhibit at least one polarization state 101 (e.g., for a p-polarization type). In some embodiments, substantially collimated light 100 may be transmitted and/or reflected to various degrees based on the defined block or pass axes in the optical film 300.

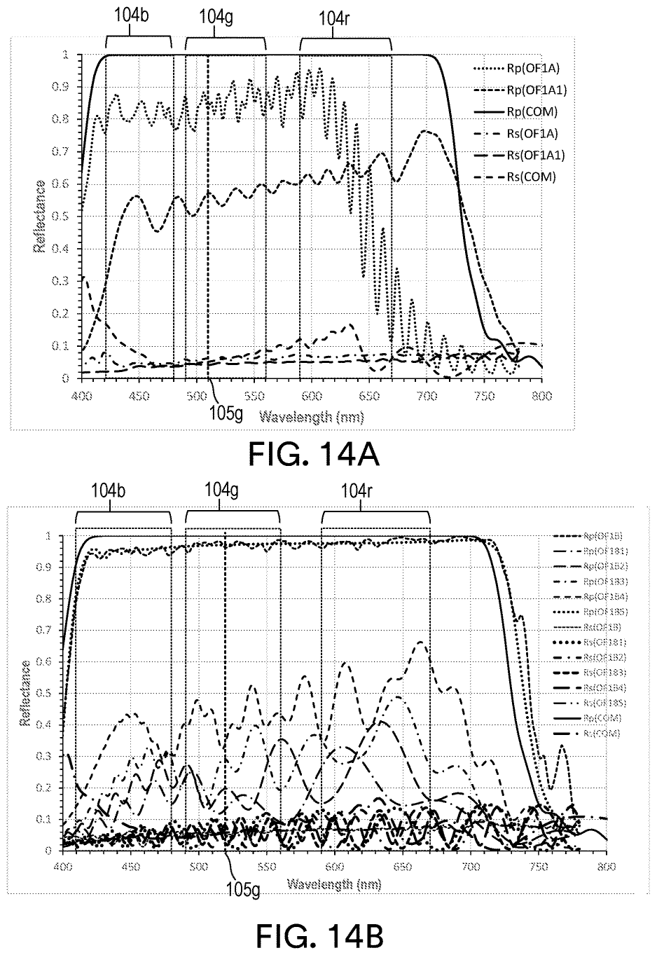

That is, optical film 300 may be configured to have a block axis which may substantially block transmission (i.e., reflect) light of one polarization type, and substantially transmit light of an opposite polarization type. Optical film 300 may also have an opposing pass axis, which would transmit and/or reflect light opposite to that of the block axis. Additional details on the optical characteristics of one embodiment of optical film 300 are presented in FIGS. 14A and 14B discussed elsewhere herein.

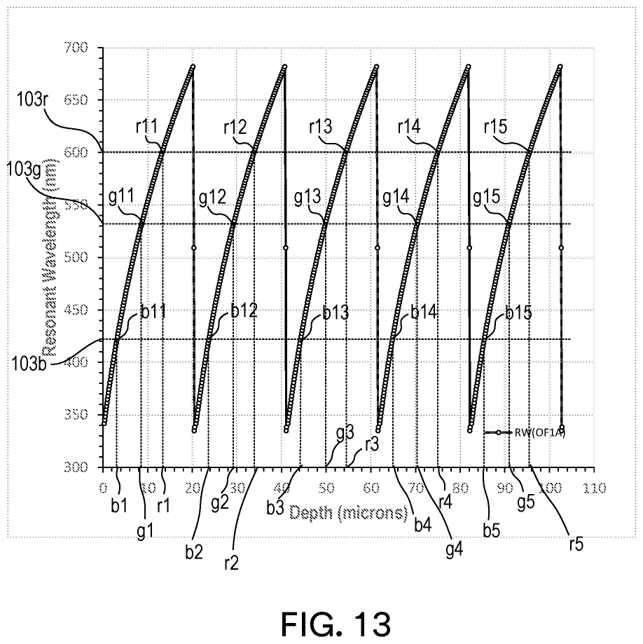

FIG. 13 provides a plot of resonant wavelengths of the ORUs versus the depths of the ORUs for an optical film, such as optical film 300 of FIG. 1. The following discussion relies upon terms defined in of FIG. 12, as well as the reflectance plots in FIGS. 14A and 14B, discussed elsewhere herein.

In some embodiments, for a substantially collimated light 100 (see FIG. 12) incident on optical film 300 at a first incident angle θ, for at least one polarization state 101 (see FIG. 12), and for at least a first blue wavelength 103b (e.g., 420 nm, FIG. 13), a first green wavelength 103g (e.g., 520 nm), and a first red wavelength 103r (e.g., 600 nm) in respective blue 104b, green 104g, and red 104r wavelength ranges (see FIGS. 14A and 14B) extending from about respective 420 nm, 490 nm, and 590 nm to about respective 480 nm, 560 nm, and 670 nm, optical film 300 may include at least three blue ORUs b11-b15, at least three green ORUs g11-g15, and at least three red ORUs r11-r15 that have resonant wavelengths within 20%, or within 15%, or within 10%, or within 5%, or within 2.5%, or within 1% of the respective first blue 103b, green 103g, and red 103r wavelengths. In some embodiments, for each of the at least three blue ORUs b11-b15, at least three green ORUs g11-g15, and at least three red ORUs r11-r15, the ORUs are spaced apart along a thickness direction (e.g., the z-axis of FIG. 1, and represented by the x-axis “Depth” of FIG. 13) of optical film 300 by at least 2 microns, or at least 3 microns, or at least 4 microns, or at least 5 microns, or at least 6 microns, or at least 7 microns, or at least 8 microns, or at least 9 microns, or at least 10 microns, or at least 12 microns, or at least 15 microns, or at least 17 microns, or at least 20 microns.

For example, for the at least three blue ORUs b11-b15, b11 is shown at depth b1 (about 4 microns), b12 is shown at depth b2 (about 22 microns), b13 is shown at depth b3 (about 42 microns), b14 is shown at depth b4 (about 66 microns), and b15 is shown at depth b5 (about 86 microns). Similar spacings are shown for the at least three green ORUs g11-g15 and the at least three red ORUs r11-r15.

FIGS. 14A and 14B provide plots of optical reflectance versus wavelength for an optical film, such as optical film 300 in FIG. 1. A summary of values from the plot in FIG. 14A is provided below in Table 1, and a summary of values from the plot in FIG. 14B is provided below in Table 2. In the following discussion, references are made to elements introduced in FIGS. 1, 8, 9, and 12.

For a substantially collimated light 100 (FIG. 12) incident on optical film 300 at a first incident angle θ, for at least one polarization state 101 (e.g., p-pol type), and for at least a first wavelength 105g (e.g., 520 nm as shown in FIGS. 14A/14B) in a visible wavelength range extending from about 420 nm to about 680 nm, the plurality of the ORUs and at least one of the groups 80-84, 90-94 (FIGS. 8 and 9) in the at least three non-overlapping groups, may have respective optical reflectances R and R1, such that R>R1>15%, or 20%, or 25%, or 30%, or 35%, or 40%, or 45%, or 50%, and R/R1≥1.1, or 1.2, or 1.3, or 1.4, or 1.5, or 2, or 3, or 4, or 5, or 6, or 7, or 8, or 9, or 10, or 15, or 20.

For example, looking at Table 1, at the row for 520 nm (i.e., first wavelength 105g), the reflectance value R for optical film OF1A (first column) is 0.87, or 87%, and the reflectance value R1 for ORU OF1A1 (second column) is 0.54, or 54%. Looking at Table 2, at the row for 520 nm, R for optical film OF1B (first column) is 96%, and the R1 values for each of the ORUs shown is OF1B1 13%, OF1B2 20%, OF1B3 29%, OF1B4 35%, and OF1B5 97%.

TABLE 1
Summary of FIG. 14A

| (nm) | Rp(OF1A) | Rp(OF1A1) | Rp(COM) | Rs(OF1A) | Rs(OF1A1) | Rs(COM) |
|---|---|---|---|---|---|---|
| 420-680: | 0.76 | 0.57 | 1.00 | 0.06 | 0.05 | 0.08 |
| 420-480: | 0.82 | 0.48 | 1.00 | 0.05 | 0.03 | 0.08 |
| 490-560: | 0.85 | 0.56 | 1.00 | 0.06 | 0.05 | 0.06 |
| 590-670: | 0.65 | 0.64 | 1.00 | 0.07 | 0.05 | 0.10 |
| 420: | 0.76 | 0.28 | 0.99 | 0.08 | 0.02 | 0.17 |
| 520: | 0.87 | 0.54 | 1.00 | 0.06 | 0.05 | 0.06 |
| 600: | 0.91 | 0.62 | 1.00 | 0.07 | 0.05 | 0.10 |

TABLE 2
Summary of FIG. 14B

| (nm) | Rp(OF1B) | Rp(OF1B1) | Rp(OF1B2) | Rp(OF1B3) | Rp(OF1B4) | Rp(OF1B5) | Rp(COM) |
|---|---|---|---|---|---|---|---|
| 420-680: | 0.97 | 0.18 | 0.23 | 0.29 | 0.44 | 0.97 | 1.00 |
| 420-480: | 0.95 | 0.14 | 0.19 | 0.25 | 0.36 | 0.95 | 1.00 |
| 490-560: | 0.97 | 0.16 | 0.20 | 0.26 | 0.42 | 0.97 | 1.00 |
| 590-670: | 0.98 | 0.23 | 0.28 | 0.36 | 0.52 | 0.98 | 1.00 |
| 420: | 0.94 | 0.06 | 0.08 | 0.14 | 0.23 | 0.95 | 0.99 |
| 520: | 0.96 | 0.13 | 0.20 | 0.29 | 0.35 | 0.97 | 1.00 |
| 600: | 0.97 | 0.32 | 0.18 | 0.29 | 0.49 | 0.98 | 1.00 |
| (nm) | Rs(OF1B) | Rs(OF1B1) | Rs(OF1B2) | Rs(OF1B3) | Rs(OF1B4) | Rs(OF1B5) | Rs(COM) |
| 420-680: | 0.06 | 0.06 | 0.06 | 0.06 | 0.06 | 0.06 | 0.08 |
| 420-480: | 0.04 | 0.04 | 0.04 | 0.04 | 0.04 | 0.05 | 0.08 |
| 490-560: | 0.06 | 0.06 | 0.06 | 0.06 | 0.06 | 0.06 | 0.06 |
| 590-670: | 0.07 | 0.08 | 0.07 | 0.07 | 0.07 | 0.07 | 0.10 |
| 420: | 0.04 | 0.05 | 0.03 | 0.04 | 0.03 | 0.04 | 0.17 |
| 520: | 0.06 | 0.05 | 0.10 | 0.02 | 0.08 | 0.06 | 0.06 |
| 600: | 0.07 | 0.09 | 0.01 | 0.11 | 0.11 | 0.07 | 0.10 |

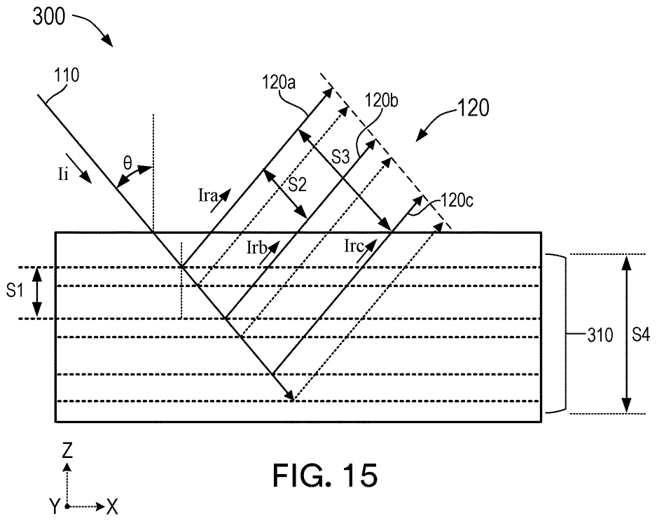

FIG. 15 is a side view of an optical stack for an optical film with controlled reflection-depth dispersion, such as optical film 300 of FIG. 1. Optical film 300 includes a plurality of polymeric layers (an optical stack) 310 stacked along a thickness direction (e.g., the z-axis shown in FIG. 15) of optical film 300. In some embodiments, each of the polymeric layers in the plurality of polymeric layers 310 may have an average thickness of less than about 500 nm, or less than about 450 nm, or less than about 400 nm, or less than about 350 nm, or less than about 300 nm, or less than about 250 nm, or less than about 200 nm, or less than about 150 nm. such that when an optical light ray 110 having a first visible wavelength in a visible wavelength range extending from about 420 nm to about 680 nm is incident on the plurality of polymeric layers 310 at a first incident angle θ of at least 10 degrees, or at least 15, or at least 20, or at least 25, or at least 30, or at least 35, or at least 40, or at least 45 degrees, the plurality of polymeric layers 310 reflects the incident light 110 as a reflected light 120 including a plurality of spaced apart substantially parallel reflected light rays 120a, 120b, and 120c. In some embodiments, each of the reflected light rays 120a, 120b, and 120c may have the first visible wavelength. In some embodiments, a separation S2 between at least two adjacent reflected light rays in the plurality of reflected light rays may be greater than an average total thickness S1 of at least 10, or at least 20, or at least 30, or at least 40, or at least 50, or at least 60, or at least 70, or at least 80, or at least 90, or at least 100 sequentially stacked polymeric layers in the plurality of polymeric layers 310.

In some embodiments, the polymeric layers in the plurality of polymeric layers 310 may have a total thickness S4, wherein the reflected light rays 120a, 120b, 120c include at least one middle light ray (e.g., 120b) disposed between first (e.g., 120a) and second (e.g., 120c) end light rays, and wherein a separation S3 between the first 120a and second 120c end light rays is less than about 2S4, or less than about 1.9S4, or less than about 1.8S4, or less than about 1.7S4, or less than about 1.6S4, or less than about 1.5S4, or less than about 1.4S4 (e.g., about 1.4S4).

In some embodiments, when substantially monochromatic light ray 110 has an optical intensity Ii and is incident on the plurality of polymeric layers 310 at a first incident angle θ of at least 5 degrees, or at least 10 degrees, or at least 15 degrees, or at least 20 degrees, or at least 25 degrees, or at least 30 degrees, or at least 35 degrees, or at least 40 degrees, or at least 45 degrees, the plurality of polymeric layers 310 may reflect the incident light ray 110 as at least two spaced apart reflected light rays 120a-120c having corresponding at least two optical intensities Ira and Irb. In some embodiments, each of ratios Ira/Ii and Irb/Ii may be greater than about 0.1, or greater than about 0.15, or greater than about 0.20, or greater than about 0.25, or greater than about 0.3, or greater than about 0.35, or greater than about 0.4, or greater than about 0.45, or greater than about 0.5. In some embodiments, at least one of the ratios Ira/Ii and Irb/Ii may be less than about 0.9, or less than about 0.85, or less than about 0.8, or less than about 0.75, or less than about 0.7, or less than about 0.65, or less than about 0.6, or less than about 0.55, or less than about 0.5.

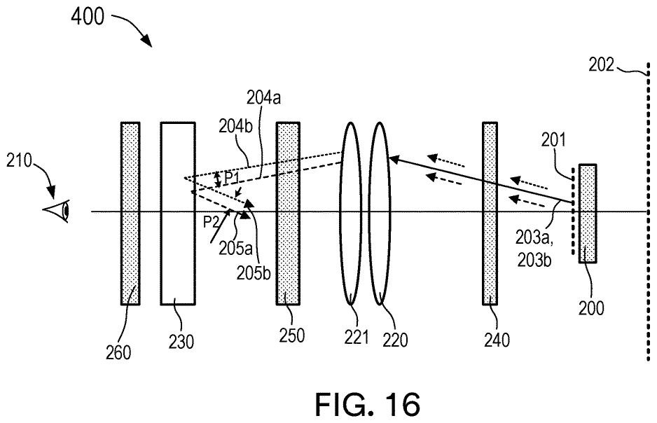

FIG. 16 is a side view of an optical system with controlled reflection-depth dispersion, including an optical film similar to optical film 300 in FIG. 1. In some embodiments, optical system 400 may include a display 200, at least one optical component 220, 221 (e.g., an optical lens or pair of lenses) having chromatic dispersion, and an optical film 230 (e.g., for example, optical film 300 of FIG. 1) having a plurality of polymeric layers (e.g., the plurality of polymeric layers 310 of FIG. 15) and configured to at least partially compensate for the chromatic dispersion of the at least one optical component 220, 221.

In some embodiments, display 200 may be configured to form and emit an image 201 comprising coincident first 203a and second 203b emitted image rays having respective first (e.g., blue) and second (e.g., red) wavelengths at least about 20 nm, or at least about 50 nm, or at least about 75 nm, or at least about 100 nm, or at least about 125 nm, or at least about 150 nm, or at least about 175 nm, or at least about 200 nm apart. In some embodiments, the optical system may be configured to display a virtual image 202 of the emitted image to a viewer 210. In some embodiments, the first and second wavelengths may be within a visible wavelength range extending from about 420 nm to about 680 nm.

In some embodiments, an optical interaction between the at least one optical component 220, 221 and the coincident first 203a and second 203b emitted image rays laterally separates the first 204a and second 204b emitted image rays so that, when incident on optical film 230, the first 204a and second 204b emitted image rays have respective optical intensities I1 and I2 and are separated by a first distance P1. In some embodiments, optical film 230 may reflect the incident first 204a and second 204b emitted image rays as respective reflected first 205a and second 205b image rays having respective optical intensities Q1 and Q2 and separated by a second distance P2. In some embodiments, the ratio Q1/I1 may be greater than or equal to 0.15, or greater than or equal to 0.2, or greater than or equal to 0.3, or greater than or equal to 0.4). In some embodiments, Q2/I2 may be greater than or equal to 0.15, or greater than or equal to 0.2, or greater than or equal to 0.3, or greater than or equal to 0.4. In some embodiments, P2 may be less than P1 by at least 10%, or at least 20%, or at least 50%, or at least a factor of 2, or at least a factor of 2.5, or at least a factor of 3, or at least a factor of 5, or at least a factor of 10, or at least a factor of 50, or at least a factor of 100.

In some embodiments, optical film 230 may further include a reflective polarizer, such that for a substantially normally incident light, the reflective polarizer reflects at least 60%, or at least 55%, or at least 70%, or at least 75%, or at least 80%, or at least 85%, or at least 90% of the incident light polarized along a first in-plane direction (e.g., polarized along an x-axis of optical film 230) and may transmit at least 60%, or at least 55%, or at least 70%, or at least 75%, or at least 80%, or at least 85%, or at least 90% of the incident light polarized along an orthogonal second in-plane direction (e.g., the y-axis of optical film 230.

In some embodiments, optical system 400 may further include a partial reflector 240, such that for a substantially normally incident light and for each of mutually orthogonal polarization states, the partial reflector reflects at least 30%, or at least 35%, or at least 40%, or at least 45% of the incident light and transmits at least 30%, or at least 35%, or at least 40%, or at least 45% of the incident light.

In some embodiments, optical system 400 may further include a retarder layer 250 configured to change a phase of a normally incident light having the first or second wavelengths by at least 20 degrees, or at least 25 degrees, or at least 30 degrees, or at least 35 degrees, or at least 40 degrees, or at least 45 degrees.

In some embodiments, optical system 400 may further include an absorbing polarizer 260, such that for a substantially normally incident light, the absorbing polarizer absorbs at least 60%, or at least 55%, or at least 70%, or at least 75%, or at least 80%, or at least 85%, or at least 90% of the incident light polarized along a first in-plane direction (e.g., along the x-axis) and transmits at least 60%, or at least 65%, or at least 70%, or at least 75%, or at least 80%, or at least 85%, or at least 90% of the incident light polarized along an orthogonal second in-plane direction (e.g., along the y-axis).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. An optical film comprising a plurality of optical repeat units (ORUs) co-extruded and co-stretched with one another and numbering at least 10 in total, each of the ORUs having an average thickness of less than about 1500 nm and comprising at least a polymeric A layer and a different polymer B layer, the ORUs sequentially numbered from a same first major side of the optical film to an opposite second major side of the optical film,
such that when adjacent data points in a scatter plot of thicknesses versus the numbers of the ORUs are connected with straight line segments to form a continuous line plot, then the continuous line plot comprises a plurality of first lines where the ORU thickness in all of the first lines substantially increases with a same one of increasing and decreasing ORU number, alternating with, and intersecting, a plurality of second lines where the ORU thickness in all of the second lines substantially decreases with the same one of increasing and decreasing ORU number, the intersection points forming at least three peaks alternating with at least two valleys.

2. The optical film of claim 1, wherein at least two of the first lines in the plurality of the first lines are substantially parallel.

3. The optical film of claim 1, wherein at least two of the second lines in the plurality of the second lines are substantially parallel.

4. The optical film of claim 1 being a reflective polarizer.

5. An optical film comprising a plurality of optical repeat units (ORUs) co-extruded and co-stretched with one another and numbering at least 10 in total, each of the ORUs having a peak reflectivity at a corresponding resonant wavelength (RW) and comprising at least a polymeric A layer and a different polymer B layer,
such that when in a scatter plot of the RWs of the ORUs versus depths of the ORUs relative to a same major side of the optical film, adjacent data points are connected with straight line segments to form a continuous line plot, then the continuous line plot comprises a plurality of first lines where the ORU RW in all of the first lines substantially increases with a same one of increasing and decreasing ORU depth, alternating with, and intersecting, a plurality of second lines where the ORU RW in all of the second lines substantially decreases with the same one of increasing and decreasing ORU depth, the intersection points forming at least three peaks alternating with at least two valleys.

6. An optical system comprising:
a display configured to form and emit an image comprising coincident first and second emitted image rays having respective first and second wavelengths at least about 20 nm apart, the optical system configured to display a virtual image of the emitted image to a viewer;
at least one optical component having chromatic dispersion; and
an optical film comprising a plurality of polymeric layers and configured to at least partially compensate for the chromatic dispersion of the at least one optical component;
such that an optical interaction between the at least one optical component and the coincident first and second emitted image rays laterally separates the first and second emitted image rays so that, when incident on the optical film, the first and second emitted image rays have respective optical intensities I1 and I2 and are separated by a first distance P1, the optical film reflecting the incident first and second emitted image rays as respective reflected first and second image rays having respective optical intensities Q1 and Q2 and separated by a second distance P2, Q1/I1≥0.15, and P2 less than P1 by at least 10%.

7. The optical system of claim 6, wherein the optical film comprises a reflective polarizer, such that for a substantially normally incident light, the reflective polarizer reflects at least 60% of the incident light polarized along a first in-plane direction and transmits at least 60% of the incident light polarized along an orthogonal second in-plane direction.

8. The optical system of claim 6, wherein the at least one optical component comprises at least one optical lens.

9. The optical system of claim 6 further comprising a partial reflector, such that for a substantially normally incident light and for each of mutually orthogonal polarization states, the partial reflector reflects at least 30% of the incident light and transmits at least 30% of the incident light.

10. The optical system of claim 6 further comprising a retarder layer configured to change a phase of a normally incident light having the first or second wavelengths by at least 20 degrees.

11. The optical system of claim 6 further comprising an absorbing polarizer, such that for a substantially normally incident light, the absorbing polarizer absorbs at least 60% of the incident light polarized along a first in-plane direction and transmits at least 60% of the incident light polarized along an orthogonal second in-plane direction.

12. The optical system of claim 6, wherein the first and second wavelengths are within a visible wavelength range extending from about 420 nm to about 680 nm.
